(19) United States
(12) Patent Application Publication
(10) Pub. No.: US 2010/0250120 A1
(43) Pub. Date: Sep. 30, 2010

(54) MANAGING STORAGE AND DELIVERY OF NAVIGATION IMAGES

(75) Inventors: Roman Waupotitsch, Redmond, WA (US); Billy Chen, Bellevue, WA (US); Eyal Ofek, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/416,127

(22) Filed: Mar. 31, 2009

(51) Int. Cl. G01C 21/26; H04N 7/00

(52) U.S. Cl. 701/207; 348/36; 348/E07.001

(57) ABSTRACT

The storage and/or transmission of image bubbles may be managed for effective use of space and/or time. In one example, a street-view application allows a user to navigate through an image at ground level. The application makes use of panoramic images called “bubbles,” which are captured at spatial intervals. The user can navigate through the images by changing position, or by changing the direction of view. Various aspects of how the bubbles are stored or transmitted may be controlled, in order to make effective use of the bandwidth that is available to transmit the bubbles. Examples of these aspects may include: how much of a given bubble is transmitted; the resolution at which the bubble is transmitted; and/or the spatial frequency at which the user moves through the bubbles.

### BACKGROUND

Some map and navigation applications offer a street-level view feature, which allows a user to see an image of the street that he or she is navigating. This feature typically allows a user to move backward and forward along a street, to turn at intersections, and to pan left, right, up, and down.

The data used to provide a street view is typically a set of images called “bubbles.” A bubble is a panoramic image, such as a cylindrical panorama, spherical panorama, etc. Typically, a car with an attached panoramic camera drives through streets and captures bubble images at regular distance intervals—e.g., every ten meters. Typically, an on-board Global Positioning System (GPS) is attached to the camera and records the car's geographic position at the time the image was captured. The image is stored together with its corresponding geographic data. Then, when a user of a map or navigation application requests to see a street-level view, an image is retrieved that corresponds to the geographic location that the user wants to see, and the image is shown to the user. Since the image is typically a panoramic image, the entire image is normally not shown to the user. Rather, a particular subset of the image is chosen that corresponds to the view direction that the user has chosen.

As a user navigates through streets, the view changes to reflect the user's motion. As the user moves forward or back along streets, or turns onto another street, a different bubble is shown to reflect the user's position. However, the motion typically appears somewhat choppy, because of the capture rate of the bubbles, and because of bandwidth limitations on how much data can be transmitted from a server to the user's application. If a bubble is captured every ten meters, then the motion from bubble to bubble will not appear smooth, and artifacts of the low capture rate will be quite visible to the user. Once a user is viewing a bubble, panning around the bubble usually appears seamless because, in many implementations of an image viewer, the entire bubble is transmitted to the user's application, so there is no transmission delay in viewing different parts of the bubble. However, users often move forward or backward from bubble to bubble, without panning, and only view a small portion of each bubble. In such situations, transmitting the entire bubble is a waste of bandwidth.

In short, the user experience in viewing street view images is often less than what it could be, because the transmission of image data does not make effective use of the transmission bandwidth.

### SUMMARY

Street views may be stored and transmitted at various different frame rates, and various different resolutions, in order to make effective use of transmission bandwidth. Image bubbles (e.g., those used in street-view or other navigation applications) may be captured at a relatively high spatial rate, such as one frame every three meters. The images may be sliced into several viewing tiles, and the tiles may be sampled at various different resolutions.

For example, a cylindrical bubble might be divided into eight separate arcs, each representing a forty-five degree slice of a panoramic view. In the example of a cylindrical panorama, each arc is a tile of the panorama. Bubbles representing the various capture positions along a street could be stored, in sequence, in a multi-stream file. Each stream could represent a specific viewing arc. Thus, if there are eight streams labeled A-H, stream A might store the 0°-45° arc of the bubbles, stream B might store the 45°-90° arcs of the bubble, etc. Since the different arcs are separated, when a user is moving along a street, it is possible to transmit, to the viewing application, only the arc(s) that represent the direction in which the user is looking and/or moving. This technique conserves bandwidth. The bandwidth saved transmitting only specific arcs of a bubble, rather than the entire bubble, may be used to transmit additional images captured at smaller intervals, thereby allowing transitions between the images to appear smoother. Similarly, a spherical bubble could be divided into tiles—e.g., each tile could be a lune of a hosohedron, a face of an icosahedron, etc. Regardless of the shape of the bubble or the manner in which the bubble is tiled, each tile can be represented in its own stream, and can be served separately from the other tiles.

In addition to separating bubbles into separate spatial portions such as arcs or lunes, bubbles may also be stored and/or transmitted at different resolutions. So, a given bubble may be sampled at 64×64 pixels, 128×128 pixels, 256×256 pixels, etc. Depending on availability of bandwidth or other considerations, images may be provided to an application at different resolutions. For example, if a user is both moving forward and panning, then serving images to the user may involve transmitting both new bubbles and more than one tile of each bubble. Since transmitting an additional tile of the bubble consumes bandwidth, use of the bandwidth may be managed by transmitting lower resolutions of the images so that a larger spatial portion of the panoramic image can fit in the amount of available bandwidth.

Other techniques may also be used to manage bandwidth and/or to affect the user experience. For example, if the user is moving through a street quickly, then the user might receive an image from every second bubble or every third bubble, thereby conserving bandwidth by not transmitting images from some of the bubbles. Conversely, if the user is moving slowly through a street, then images between bubbles might be interpolated from surrounding bubbles, thereby smoothing out the visualization of the motion. Interpolation might be performed on a server or on a client.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example set of bubbles that may be captured and stored in a database.

FIG. 2 is a block diagram of an example application in which image data is used to navigate through streets.

FIG. 3 is a block diagram of an example way to represent bubbles and sets of bubbles.

FIG. 4 is a block diagram of an example set of files that store sequences of bubbles at different resolutions.

FIG. 5 is a graph that shows certain tradeoffs that may be made when deciding how to use available transmission bandwidth.

FIG. 6 is a flow diagram of an example process in which images may be served and displayed.

FIG. 7 is a block diagram of some example criteria that may affect the choice of how images are delivered.

FIG. 8 is a block diagram of an example system in which images may be served and used by an application.

FIG. 9 is a block diagram of example components that may be used in connection with implementations of the subject matter described herein.

### DETAILED DESCRIPTION

Images captured at street-level are popular in online map applications. For example, street-level images may be combined with driving directions, so that a user can see what a destination looks like. Street-level images may be served as cylindrical panoramas, spherical panoramas, cube maps, or any other similar type of view. Such views may be referred to as “bubble views,” or just “bubbles”, and they enable a user to see the world in any direction around a point.

Bubble views work well when the user stands at one point. If the entire bubble is served to the user's application, the user can pan around the bubble seamlessly. However, if the user wants to simulate travel down a street, several spatially-separated bubbles are used, which raises the issue of creating a transition between the bubbles. In a naive implementation, the user receives a full bubble for each new position. For example, some map applications allow a user to move down a street in increments of ten meters, so as the user moves down a street, a succession of bubbles spaced ten meters apart are served to the user's application. However, this technique results in a poor experience. Since the bubbles are spaced relatively far apart from each other, the user will see transition artifacts. The motion between bubbles typically appears choppy.

One way to provide smooth transitions between images is to increase the spatial frequency of bubbles. For example, instead of capturing bubbles every ten meters, one bubble might be captured every three meters. This density enables a smoother experience when traveling between bubbles. However, sending each bubble individually involves having high bandwidth available. Since transmitting a new bubble every three meters instead of every ten meters represents more than a three-fold increase in the amount of data, the transmission medium may not provide sufficient bandwidth to support the transmission of a bubble every three meters.

To address bandwidth limitations while providing smooth transitions, two properties may be exploited: spatio-temporal redundancy across bubbles, and viewer locality. With regard to spatio-temporal redundancy, there is much redundancy across bubbles. For example, two neighboring bubbles in an urban street will capture similar views of the buildings there. Instead of sending two copies of the building, one copy might be sent as a reference frame, along with the deltas that allow one image to be transformed to another image. This is similar to video compression across frames.

With regard to viewer locality, it is noted that a typical viewer only shows the user a portion of the bubble. For example, a typical viewer has a 45° field-of-view (FOV). Thus, bandwidth can be used more effectively by dividing, for example, a cylindrical bubble into arcs representing different fields of view and sending only the arc corresponding to the view that is going to be shown to the user (and possibly pre-loading adjacent arcs to reduce delay in case the user pans in one direction or the other).

Given these two properties, a set of bubbles may be encoded into streams. A multi-stream file is composed of multiple videos, but allows for random access among the streams. Each video is a subset of the entire bubble. As a user pans in a bubble, different streams of video are displayed to fill the user's FOV. As a user travels down a street the videos are played forward or backward.

Additionally, various other techniques may be used to manage the use of transmission bandwidth and to increase the smoothness of transitions. For example, if a user is using an application to travel, virtually, down a street and is moving quickly, then the user may be shown fewer than all of the bubbles. Thus, if a bubble was captured every three meters, the user might be shown every other bubble, so a new view would be shown only every six meters. If the user is moving quickly through images of the street, then the user might expect some to see some distortion, so this reduction in the temporal resolution of the images might be acceptable to the user under the circumstances. Another example technique is to reduce the resolution of the video images, thereby reducing the amount of bandwidth used to transmit a given bubble (or a given arc of a bubble). For example, the video file might be spatially downsampled before transmission, or several different versions of the video file could be stored, each representing a different resolution of the video. Server-side software could determine the appropriate resolution and/or frame rate to transmit, based on the available bandwidth and on the spatial and temporal scope of the images that the viewing application is requesting to see.

Another example technique that may be used is to increase the temporal resolution of the video beyond its frame capture rate. For example, if a user is using a viewer application to navigate very slowly through a street, the viewer might show a new bubble every 1.5 meters. If the images were captured at the rate of one bubble every three meters, then intermediate bubbles may be interpolated from the surrounding bubbles, in order to make the motion from bubble to bubble appear smoother to the user. Intermediate bubbles may be interpolated by a server and served to a client; or, a client application could be provided with programming to interpolate the intermediate bubbles, thereby avoiding the use of bandwidth to transmit intermediate bubbles.

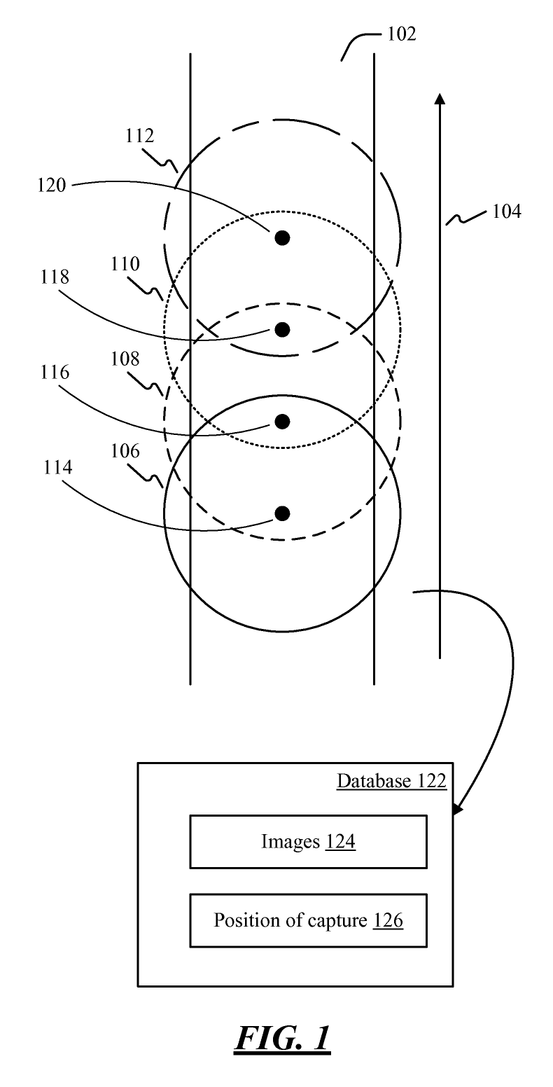

Turning now to the drawings, FIG. 1 shows an example set of bubbles that may be captured and stored in a database. FIG. 1 shows a top plan view of a street 102. A vehicle may drive down street 102 in the direction of arrow 104, and may capture panoramic images (bubbles) as it drives. (In the example of FIG. 1, the bubbles are cylindrical panoramas, although it will be understood that bubbles could be any appropriate type of image, such as a spherical panorama, cube map, etc.) For example, panoramic images 106, 108, 110, and 112 (which are shown in different line patterns so that they are visually distinguishable from each other in the drawing) may be captured from points 114, 116, 118, and 120, respectively. The vehicle that captures panoramic images 106-112 may be equipped with a camera and a global positioning system (GPS) receiver. The camera captures the images, and the GPS receiver records the vehicle's position when the images were captured. (Panoramic images 106-112 may be referred to herein as bubbles 106-112.)

As panoramic images 106-112 are captured, the images may be stored in database 122. For each image that is captured, database 122 may store the image 124 in some format (e.g., a bitmap file, a Joint Photographic Experts Group (JPEG) file, etc.), and may also store the position 126 at which image 124 was captured.

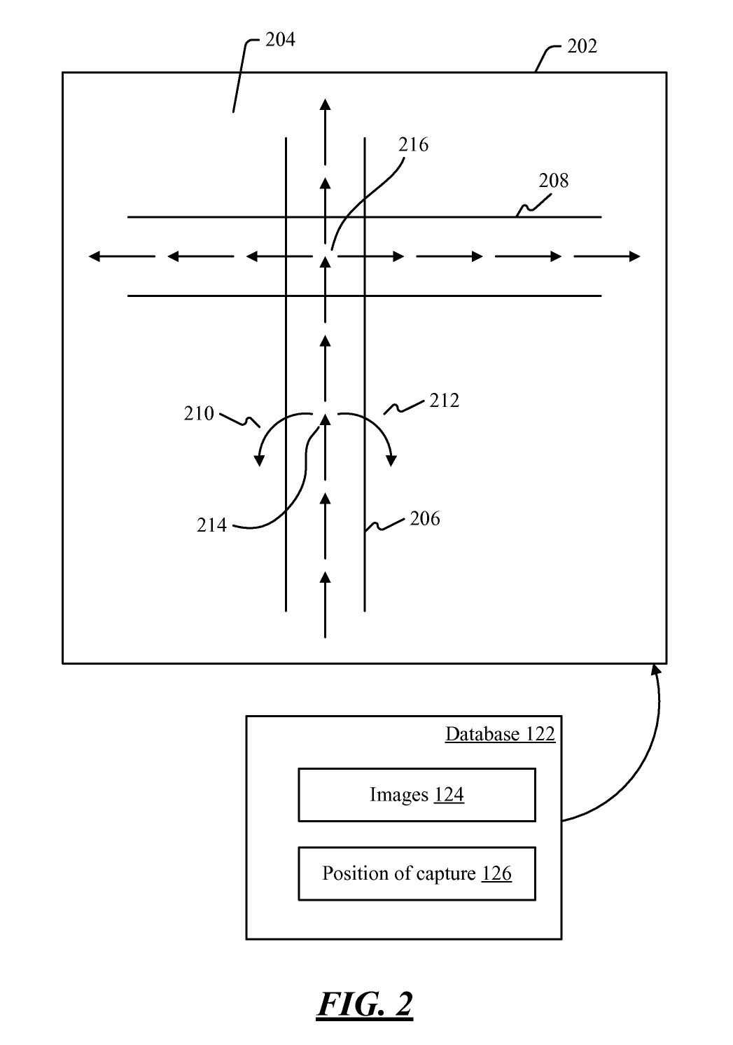

The captured panoramic images may be used to navigate through streets. FIG. 2 shows an example application in which image data is used to navigate through streets.

Application 202 displays a map 204. As an example, map 204 has two intersecting streets 206 and 208, although a map could have any number of streets. Bubbles were captured, at some point in time, along streets 206 and 208, and those bubbles are stored in database 122. For each bubble, the image 124 is stored, along with the position 126 at which image 124 was captured. The specific points along streets 206 and 208 at which each bubble was captured are shown by the ends of the arrows that lie along streets 206 and 208. A bubble was captured at the position corresponding to the end of each arrow. As a user uses application 202 to view images of the streets, the user can change position by moving from the end of one arrow to the end of another arrow. Motion from one arrow to the next may be a user-driven process, in the sense that the motion may occur upon a click (or other indication) from a user. In another example, the motion may be automated—i.e., the application may move from one location to the next at some speed without ongoing user interaction.

At each location at which a bubble was captured, it is possible to pan around and look in any direction from the point at which the bubble image was captured. For example, arrows 210 and 212 indicate that when the bubble corresponding to arrow head 214 is being displayed, a user may pan left (arrow 210) or right (arrow 212), thereby changing which part of the bubble is being viewed. Moreover, in addition to moving forward and backward along a street, when an intersection is reached (e.g., at the bubble represented by arrow head 216), the user may choose to continue on the same street, or may turn right or left on the intersecting street.

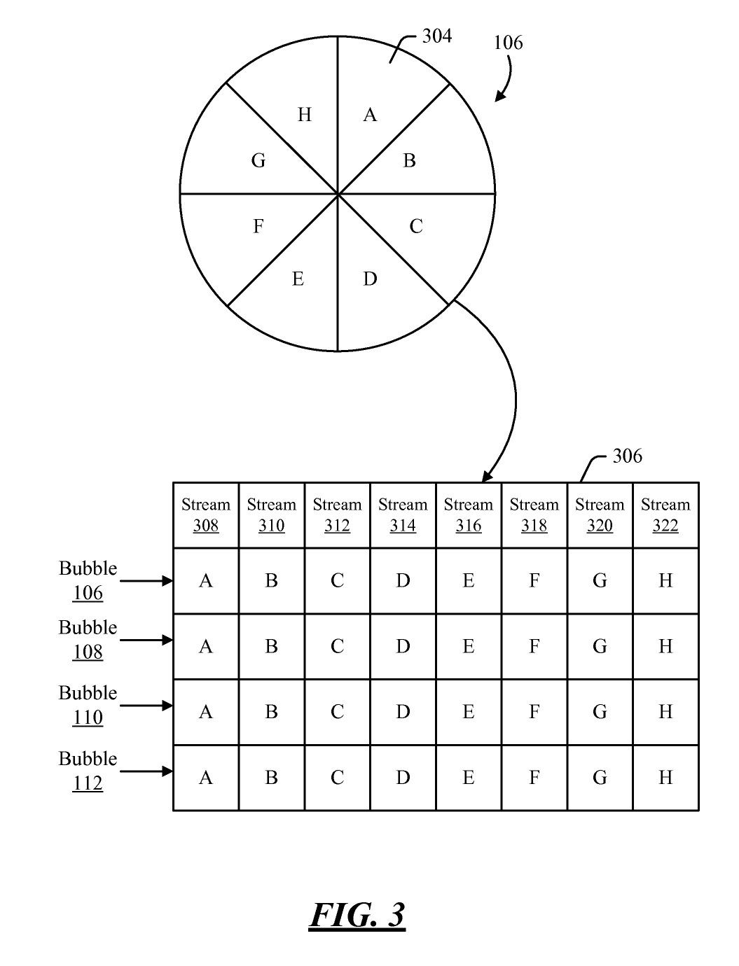

As noted above, cylindrical bubbles may be divided into different arcs of a panorama. Similarly, other types of bubbles could be tiled in other ways—e.g., a spherical panorama could be divided into lunes of a hosohedron, or faces of an icosahedron or other Platonic solid. A cube map could be divided into faces of a cube. And so on. By way of illustration (but not limitation) some of the examples herein are described in terms of cylindrical panoramas. Thus, FIG. 3 shows, in the case one way to represent bubbles and sets of adjacent bubbles.

Bubble 106 (introduced in FIG. 1) is shown in a top plan view, looking downward upon the cylindrical panorama represented by the bubble. Bubble 106 is divided into eight arcs, labeled A-H. Each arc represents a 45° slice or portion of a bubble. For example, if 0° corresponds to the direction that is looking directly forward from the position at which the bubble is captured (e.g., from the center of bubble 106 toward the top of the page on which FIG. 1 appears), then arc 304 (labeled “A”) represents the portion of the bubble from 0°-45°. The use of equally-sized 45° arcs is merely an example; a cylindrical bubble could be divided into any number of arcs, which may be of equal or unequal angles. (In this example, the panoramic image is presumed to be captured as a full circle—i.e., through a full 360° angle—although it is noted that a cylindrical panoramic image could be captured through any angle. In greater generality, it may be said that panoramic images are captured through some visual field—which may or may not be cylindrical—and the visual field may be divided into various tiles or portions.)

The various arcs may be stored in individual streams of a multi-stream file 306. For example, file 306 contains eight streams 308, 310, 312, 314, 316, 318, 320, and 322, each corresponding to a different arc in a given bubble. Thus, in the image represented by bubble 106, the portion of that image corresponding to arc A is stored in stream 308, the portion corresponding to arc B is stored in stream 310, and so on. Thus, when a user pans around a bubble, different streams may be accessed in order to show the portion of the bubble that corresponds to the direction of view to be shown to the user.

Successive bubbles may be stored in file 306 in the sequence in which they were captured as the capturing device (e.g., a vehicle) moved along a street. For example, if bubbles 106, 108, 110, and 112 (shown in FIG. 1) are captured successively as a vehicle moved down a street, then these bubbles may be stored successively within file 306. Thus, bubble 108 (like bubble 106) may be divided into eight arcs A-H. Bubble 108's arc A may be stored in stream 308 directly after bubble 106's arc A; bubble 108's arc B may be stored in stream 308 directly after bubble 106's arc B, and so on. Thus each stream represents a sequence of arcs captured from successive bubbles. So, if a user uses a navigation application to view the motion through the street on which the bubbles were captured, and if the user is looking in the direction represented by arc A, then motion through the street can be simulated by serving, to the user's viewing application, successive images from stream 308. If the user's field of view is larger than 45° (e.g., if the user is looking straight ahead and can see 45° in each direction for a total of 90°), then motion can be simulated by showing the user successive images combined from streams 308 and 322 (arcs A and H). In other words, dividing the arcs into separate streams of a file and storing the bubbles in the order in which they were captured allows moving images from a specific arc (or arcs) of the bubbles to be shown by serving images from one or more of the streams. So, when images are to be served over a limited bandwidth connection, the separation of the different arcs into streams simplifies the process of serving only the portions of the bubbles that will be shown to the user, and conserving bandwidth by not serving portions of the bubble that will not be shown.

FIG. 3 shows an example in which bubbles are cylindrical panoramas, and in which the spatial portions into which the cylindrical panoramas are arcs of the cylinders. In this example, each arc is corresponds to a tile of the panorama. However, as noted above, it can readily be appreciated that a cylindrical panorama is merely an example of a bubble. Other types of bubbles could be tiled in other ways, and each separate tile could be stored in a stream of a file. For example, in the example where the bubble is a spherical panorama, each tile could be a lune of a hosohedron, where each of the separate lunes would be stored in separate streams in the manner shown in FIG. 3. Or, as another example, a spherical panorama could be approximated as an icosahedron (a twenty-faced Platonic solid in which each face is an equilateral triangle), where each stream would store a different face of the icosahedron. Or, as a further example, the bubble could be a cube, and each face of the cube could be stored in a separate stream.

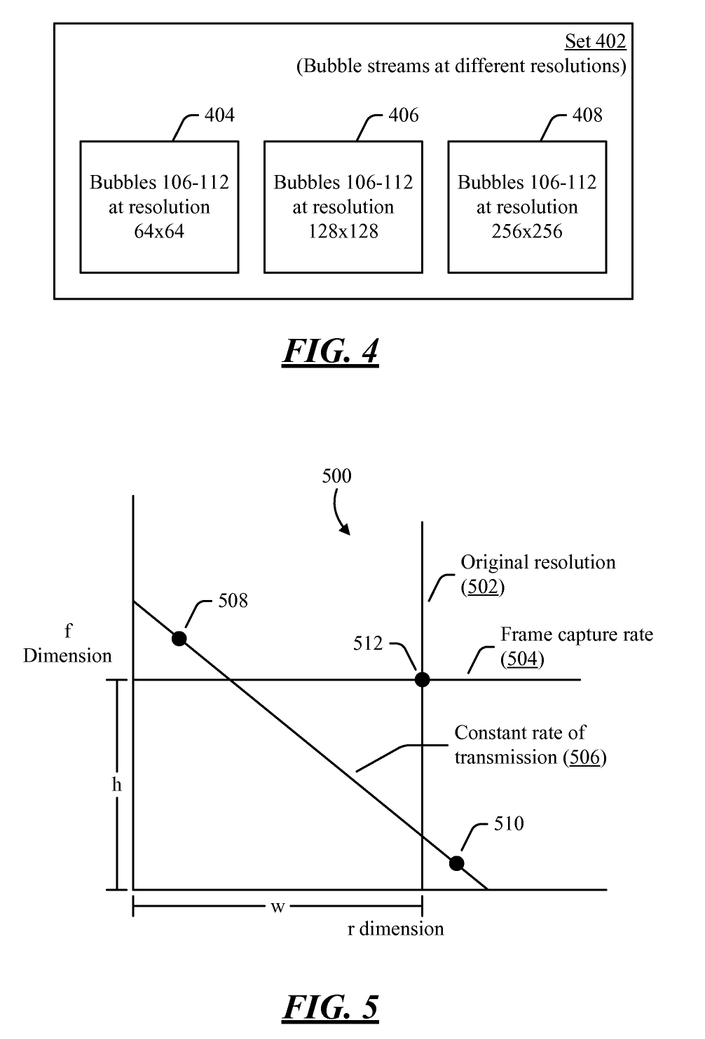

As noted above, one way to conserve data transmission bandwidth is to serve only those portions of a bubble that will actually be viewed. Another way to conserve bandwidth is to transmit images at a lower resolution from the resolution at which the images were captured. This technique effectively trades image quality for bandwidth. If a connection has a low bandwidth, then low resolution images may be transmitted in order to fit the image into the relatively small amount of bandwidth. Or, if a large number of arcs (or other kinds of tiles) of an image are to be transmitted in a small amount of time (e.g., if the user is panning from left to right quickly), then the larger number of arcs may be transmitted over a finite amount bandwidth by reducing the resolution of each tile. There are various ways to transmit low resolution images. For example, the images could be stored at their original resolution and could be spatially downsampled dynamically when the image is to be served. Or, the images could be “pre-downsampled” at several different resolutions, and several different files could store sequences of the same bubble images at different resolutions. FIG. 4 shows an example of the latter, in which different files store images at different resolutions.

Set 402 is a set of files that store the same sequence of bubbles at different resolutions. For example, file 404 stores a version of bubbles 106-112 at 64×64 pixels per square inch. File 406 stores a version of bubbles 106-112 at 64×64 pixels per square inch. File 408 stores a version of bubbles 106-112 at 128×128 pixels per square inch. Thus, if the bubbles were originally captured at, for example, 512×512 pixels per square inch, each of files 404-408 represents a different level of spatial downsampling of the original images. Because of the downsampling, file 404 represents the bubble images in 1.5625% of the amount of data used to represent the original images (although at a lower quality), and files 406 and 408 use 6.25% and 25%, respectively, of the space used to store the original image. These percentages represent the reduction in bandwidth that can be achieved by transmitting images (or portions of an image) at a lower resolution. Thus, if a connection has sufficient bandwidth to transmit one arc of a bubble per second at 512×512 resolution, a server application might choose to use the bandwidth to transmit one arc (or other kind of tile) at the image's original resolution in order to show the user a high quality image. Or, if the user is moving quickly down a street or is panning quickly from left to right, the server application might choose to use the same bandwidth to transmit four images at 256×256 resolution, thereby providing more images in the same amount of time, albeit at a lower quality. If the server determines to transmit images at a particular resolution, then the server may choose a specific one of the file based on the fact that the file contains images at that resolution. Various ways of deciding how to choose an appropriate use of bandwidth (e.g., by varying the number of tiles to transmit, varying the resolution, or varying the temporal frame rate) are described below.

FIG. 5 shows a graph 500 that represents certain tradeoffs that may be made when deciding how to use the available transmission bandwidth. As noted above, there are various different factors that may be changed to affect the amount of bandwidth consumed—e.g., temporal frame rate, number of arcs, frame resolution, etc. By way of example, graph 500 shows a tradeoff between two such factors, although it will be understood that, in general, the tradeoff may be modeled in an n-dimensional space, where n could be greater than two.

Graph 500 has an r dimension along the horizontal axis and an f dimension along the vertical axis. The r dimension represents the resolution of the images to be transmitted, and the f dimension represents the number of frames per unit of time to be transmitted. Vertical line 502 represents the original resolution of the image bubbles—e.g., 512×512 pixels per square inch (which, for a given image area, represents a constant number of pixels per bubble). Horizontal line 504 represents the original capture rate of bubbles—e.g., one bubble per second. In one example, the rate of bubble captured is based on unit of distance (e.g., one bubble every three meters, rather than one bubble per some number of seconds), so the capture rate per unit time may change based on the speed of the capturing device at the time the bubble was captured. However, assuming a constant rate of speed over some distance, it is possible to approximate the capture rate as being constant per unit of time. The amount of bandwidth used to transmit a given number of frames per unit of time at a given resolution is proportional to the area of the rectangle defined by the frame rate, h, and the resolution, w.

Diagonal line 506 represents a specific amount of data to be transmitted per unit of time. This amount may be equal to the maximum amount of available bandwidth of a connection, or it might be a lower number. The tradeoff between frame rate and resolution is shown by points 508 and 510. At point 508, images are transmitted at a relatively high number of frames per second, but at a relatively low resolution. At point 510, a relatively low number of images per second are transmitted, but these images are at a relatively high resolution. Both of points 508 and 510 lie along line 506, indicating that either of these choices can be accommodated in the same amount of bandwidth. Point 512 represents the intersection of the original image resolution and the original capture rate. Since that point lies beyond line 506, choosing the original capture rate and the original resolution, in this example, would represent more data than could be accommodated in the amount of bandwidth available (or, at least, more than the amount that has been allocated to transmission). Thus, in the model represented by graph 500, a combination that uses both the original resolution and the original capture rate cannot be accommodated in the available bandwidth, so a different choice could be made by lowering the frame rate or by lowering the resolution. As noted above, a model with more than two dimensions could be used. For example, if a third dimension represented the number of arcs to be transmitted, then perhaps both the original frame rate and the original resolution could be accommodated by choosing to serve a smaller field of view of each bubble.

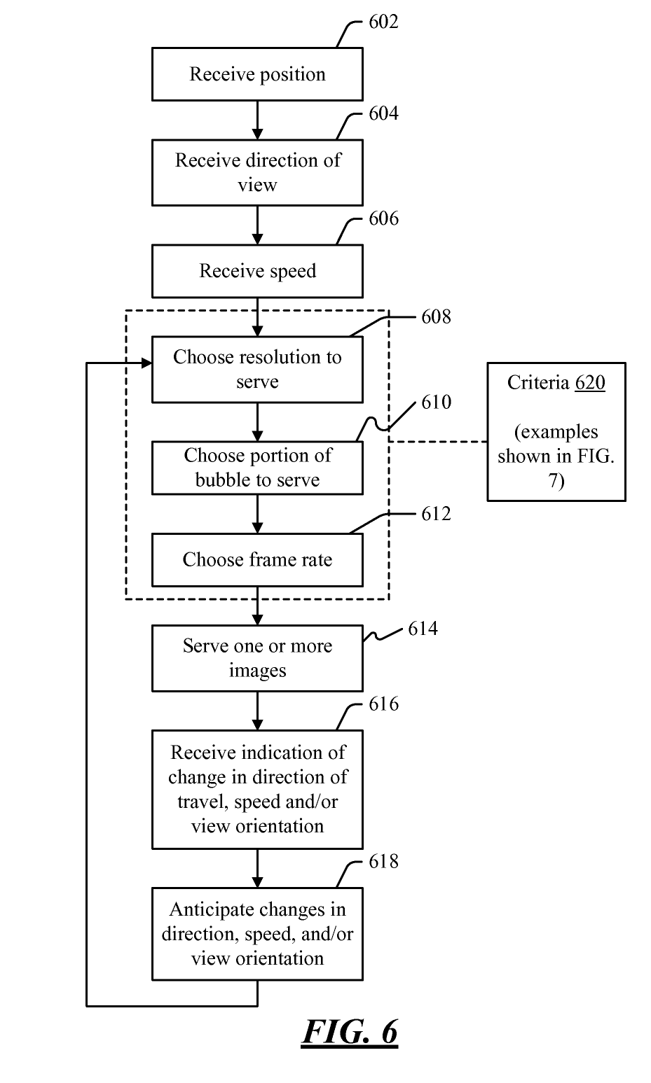

FIG. 6 shows an example process in which images may be served and displayed. The example images to be displayed may be panoramic images, or portions thereof. The process of FIG. 6 may be used as part of a viewing application in which a user views successive images, possibly at different angles, in order to simulate motion through an area in which the images were captured. Before continuing with a description of FIG. 6, it is noted that FIG. 6 shows an example in which stages of a process are carried out in a particular order, as indicated by the lines connecting the blocks, but the various stages shown in FIG. 6 may be performed in any order, or in any combination or sub-combination.

At 602, an indication of a geographic position may be received. For example, a user may use a map application, and may indicate that he or she would like to see a street-level view at a specific geographic position. The position could be identified by street address, latitude and longitude coordinates, or in any other manner. This information could be communicated from the user's application to a server, where the server provides images for use by the application.

At 604, an indication of a direction of view may be received. As described above, a bubble may comprise a panoramic image that was captured in a circle, sphere, cute, etc., centered at some point, and thus it may be possible to view images in several different directions from that point. Thus, the application that the user is using to view the images may provide, to a server, an indication of the direction in which an image is to be viewed. The direction might be selected by a user, or the application may infer a specific direction from other input that the user has provided, or the application may have some default direction. For example, the application could, by default, show a view that corresponds to a 90° arc in which the northerly direction is the center. Or, the user's interaction with a map may indicate a direction in which the user is travelling, in which case the view could be shown in a 90° arc centered on that direction (which is an example of inferring a direction from the user's actions). Or the user could provide explicit input through a keyboard or mouse, indicating which direction he or she would like to view. Regardless of the manner in which the direction is ascertained, this direction may be received by a server.

At 606, information about a speed of travel may be received. For example, a user may indicate that he or she would like to see the view along “Main Street” traveling west at twenty-five miles per hour. Or the user may be shown still images, and may be provided with user interface elements that allow the user to click on where to move from the user's current position. (E.g., the user could be shown a set of arrow heads superimposed on a street, and, when the user is ready to move, the user could click on the arrow head indicating where he would like to move.) The former example could be used to animate the user's view down a street automatically (e.g., the user could be given a view that simulates traveling in a car at twenty-five miles per hour). The latter example could be viewed as a type of manual indication of speed, in the sense that the user determines when to move to the next image, and provides this information in real time.

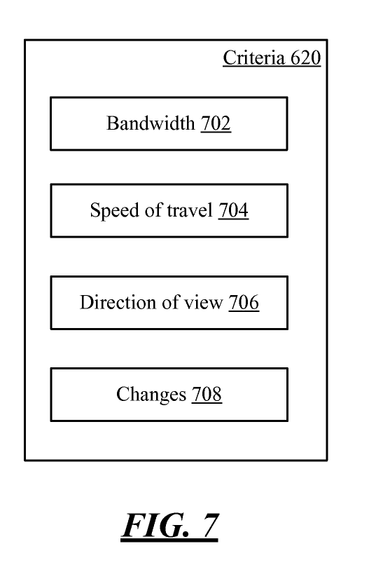

At 608, a resolution at which to display images may be chosen. At 610, a particular portion (or portions) of a bubble to be displayed may be chosen. At 612, the frame speed may be chosen. The frame speed may represent the frequency with which the image of one position is to be replaced with an image of another position, thereby providing the user with a simulation of motion. The stages at 608-612 may be performed, for example, by a server that provides images to the user's application. Moreover, the stages at 608-612 may be performed separately (as shown), or may be performed together in an integrated decision-making process, as indicated by the dashed-line box that groups these stages together in FIG. 6. As noted above, aspects of image delivery such as resolution, frame speed, and the number of portions of a bubble to be shown are part of a tradeoff that may be made concerning how to use the available transmission bandwidth while preventing the amount of data from exceeding that bandwidth. Thus, at 608-612, these choices may be made to define this tradeoff. Various criteria 620 may be used to make the decision, such as how much bandwidth is available, what speed of travel the user wants to simulate, whether the user is panning between left and right or is remaining fixed in a specific orientation, etc. Examples of criteria 620 are shown in FIG. 7, and are discussed below.

At 614, one or more images may be served based on the choices that have been made at 608-612. For example, if the user indicates that he or she is standing still at a specific point, then the arcs (or other kinds of tiles) that (either individually or collectively) encompass the user's field of view may be served. If there is sufficient bandwidth, these tiles may be served at their original resolution. If there is limited bandwidth, then a lower resolution may be used. Additionally, if there is sufficient bandwidth after the tiles corresponding to the user's field of view have been served, then a decision may be made to pre-load additional tiles from the same bubble. Even if the user is not viewing those tiles, using idle bandwidth to pre-load the tiles allows the user to pan around the bubble seamlessly, if the user chooses to do so, since the images from different directions will already be available at the user's application.

At 616 and 618, information may be collected and evaluated to determine what images to load next. For example, at 616 an indication of a change in direction of travel, speed of travel, and/or view orientation may be received by the server that provides images. This indication might be provided by the user, using the various controls that a viewing and/or navigation application provides. At 618, changes in direction, speed, or orientation may be anticipated. For example, based on a user's prior actions, either the server or the user's application may attempt to guess whether the user will be changing direction (e.g., turning at an intersection, reversing course, etc.), or whether the user will attempt to pan around a bubble (thereby changing the view orientation). In general, effective use of transmission bandwidth may involve making wise choices about how to use the bandwidth. In some cases, the bandwidth may be used to achieve a higher quality (e.g., higher-resolution) image. In other cases, the bandwidth may be used to provide a larger field of view (e.g., more arcs of a panoramic image). In other cases, the bandwidth may be used to provide smoother transitions between image frames when motion occurs (e.g., more frames per unit of time). In some cases, the choice of how to use bandwidth may involve any combination of these or other factors. At 616 and 618, information is gathered or forecast that allows choices about the use of bandwidth to be made. One specific example of how a forecast might be used to determine the use of bandwidth is as follows: If a user is moving through a street and is approaching an intersection, the system might choose to use available bandwidth to pre-load images from the various different streets that lead away from the intersection. In this way, images will be available regardless of which direction the user chooses to follow, thereby avoiding a delay in rendering the image. If bandwidth is limited, the system might compromise by pre-loading low resolution images of the various streets, and may replace the images with higher resolution images once the user chooses a direction. Thus, the user at least will be able to view some type of image without delay, pending the loading of a higher quality image.

Based on whatever information has been collected, the process shown in FIG. 6 may loop back to 608, in order to make new choices about what resolution to serve, which arcs of the bubble(s) to serve, and what frame speed to use. In general, the process shown in FIG. 6 may run a continual loop of choosing (at 608-612) the various parameters that affect how images are to be served, then providing images (at 614), and then collecting and/or forecasting data from which new choices are to be made (at 616 and 618).

Regarding the serving of image data to an application, a few aspects are to be noted.

First, the file format shown in FIG. 3 is particularly well adapted to serving the images that simulate a car (or person, or other object) moving along a street. If the images captured along a specific street are stored successively in one file, and if the images are divided into streams that correspond to specific tiles of a bubble, then showing the images that simulate motion down the street is relatively simple: each stream constitutes a video of a particular arc, so that stream can simply be played as a video. If the field of view is to be larger than one tile, then plural streams corresponding to plural arcs can be played. The streams can be played forward or backward, depending on the direction of travel to be simulated.

Second, a file containing images could incorporate the concept of a fork in the road. For example, if a road branches off in two directions, then streams could be used to represent the images from either direction. Thus, if a file that represents one road has eight streams (representing eight arcs of a bubble), then a file to represent two different roads may have sixteen streams (two sets of bubbles, with eight different arcs for each bubble). So if street A comes to a fork and then branches off into streets B and C, and if each bubble is represented in N streams, then the file could contain 2N streams. As the captured bubbles move toward the fork, the first N streams would be occupied by images from street A, and streams N+1 through 2N could be unoccupied (or could duplicate the information in streams 1 through N). Then, from the point of the fork onward, streams 1 through N could contain bubbles captured on street B, and streams N+1 through 2N could contain bubbles captured on street C. Thus, in order to simulate motion toward the fork in the road and beyond, streams of video could be played form the beginning of the file. Then, when the fork is reached, either streams 1 through N or N+1 through 2N could be played, depending on which direction the user chooses.

Third, as noted above, one aspect of providing images is variance in the frame rate—i.e., the density of frames that are shown per unit of distance or unit of time. As also noted above, there is a capture rate that represents the actual frequency with which frames were captured by a camera. In some cases, there may be reason to show frames at a higher frequency than the capture rate. For example, if the user wants to move very slowly down a street (e.g., at one mile per hour), then smoothing out the motion may involve showing motion transitions. Showing frames at a higher frequency than the capture rate involves showing some frames that were never captured. Thus, these intermediate frames may be interpolated from surrounding frames. The following is a description of one example way to interpolate intermediate frames.

Temporal information in a Motion Picture Experts Group (MPEG) encoding (or any other appropriate moving-image encoding) may be used to mimic the perspective motion of the scene without explicit computation of that perspective.

One way to perform server-side blending is to use the encoding provided by MPEG compression (or other appropriate type of compression). Take the centers of 8×8 or 16×16 squares of one frame and name them I₀, I₁, etc. Call the corresponding centers in the next frame computed by the compression I₀′, I₁′, etc. Compute a Delaunay triangulation for the centers of the first frame and then replace the coordinates of the vertices in the triangulation by prime correspondences in the second frame. Test for flipped triangles (i.e. those for which a clockwise orientation were replaced by a counterclockwise orientation during the coordinate replacement).

An intermediate frame may be calculated as follows. Consider the frames stacked in 3D space, and two matching centers (e.g. Iₖ and Iₖ′). The intermediate frames may be calculated as a weighted linear combination of Iₖ and Iₖ′ at position that is also a weighted combination of these two centers.

For a pixel for which such a match does not exist but which is inside of a triangle Tᵢ=(iₖ, iₗ, iₘ) of the first image and inside of triangle Tᵢ=(iₖ′, iₗ′, iₘ′) one may calculate the values at the appropriate linear combination of the values at the three vertices, and then may calculate the linear combination between those for the intermediate image.

Note that the intermediate images could be pre-calculated on the server (either at the time the intermediate images are to be provided, or they could be pre-calculated and stored in advance). Or, one could download relevant information to the client, which could be usable by the client to calculate the intermediate images.

As noted above, there are various aspects that may be tuned with regard to how to deliver images, such as frame rate, resolution, which tiles of a panoramic image to deliver, etc. As also noted above in connection with FIG. 6, these factors may be based on various criteria 620. FIG. 7 shows some example criteria 620 that may affect the choice of how to deliver images.

One criterion that may be used is the amount of bandwidth 702 that is available for transmission. The available bandwidth may be determined, for example, by physical limits of the transmission medium. As another example, some percentage of the transmission medium's physical bandwidth could be allocated, in which case the available amount of bandwidth would be the allocated bandwidth. For example, a particular connection may support transmission speeds of one megabyte per second, but half a megabyte may be allocated to the transmission of images for a map or navigation application. In such an example, half a megabyte per second is the available bandwidth, even though the medium could support a physically larger bandwidth. Regardless of how the available bandwidth is determined, the way in which a server chooses to deliver images to an application may be determined in a way that fits the data into the available bandwidth.

Another criterion that may be used is the speed of travel 704 that is to be simulated by a map or navigation application. For example, if a user chooses to simulate travel at one mile per hour, then the system may choose to deliver high resolution images, and may also choose to interpolate some images between the captured images, in order to make smoother transitions. On the other hand, if a user chooses to simulate motion through a street at one hundred miles per hour, this type of simulation may involve many rapid transitions between different images. Since only a finite amount of data can be transmitted in a given amount of time, the system may choose to use lower resolution images, and/or change the frame rate (e.g., transmitting every second or third captured image, while omitting the remaining images in the sequence), so that the data to be transmitted does not overflow the bandwidth. For a high-speed simulation, using lower frame rates and/or lower resolution may make sense, since the fast motion that would be shown to the user may tend to lower the user's expectation of image quality.

Another criterion that may be used is the direction of view 706 to be displayed. As described above, a particular arc or other tile (which may be represented in a particular stream of a file) may be served to an application, based on the direction in which a panoramic image is to be viewed.

A further criterion that may be used is the existence (or non-existence) of changes 708, such as changes in the viewing direction, speed of travel, direction of travel, etc. For example, if a user is simulating motion down a street at ten miles per hour while looking forward (i.e., in the direction of motion), the system may choose a particular set of tiles of a bubble to display, a particular frame rate, a particular resolution, etc., based on the available bandwidth. Suppose that, in the example of cylindrical bubbles, the system determines that this motion can be shown by transmitting the streams for two adjacent arcs of the bubbles, at a rate of three new bubbles per second, and a resolution of 256×256 pixels per square inch. Suppose that, at some later point in time, the user uses an application's controls to request to pan to the right, and the panning action takes one second to complete. Then, during this period of one second, the system not only has to serve new bubbles at the resolution and frame rate previously determined, but also has to serve additional arcs of the bubbles that are served during that one second in order to accommodate the panning motion. Transmitting these additional arcs may overwhelm the transmission medium. Thus, the system may temporarily reduce the resolution and/or frame rate to accommodate the additional arcs. The foregoing is one example of how changes in direction may affect the way in which images are transmitted.

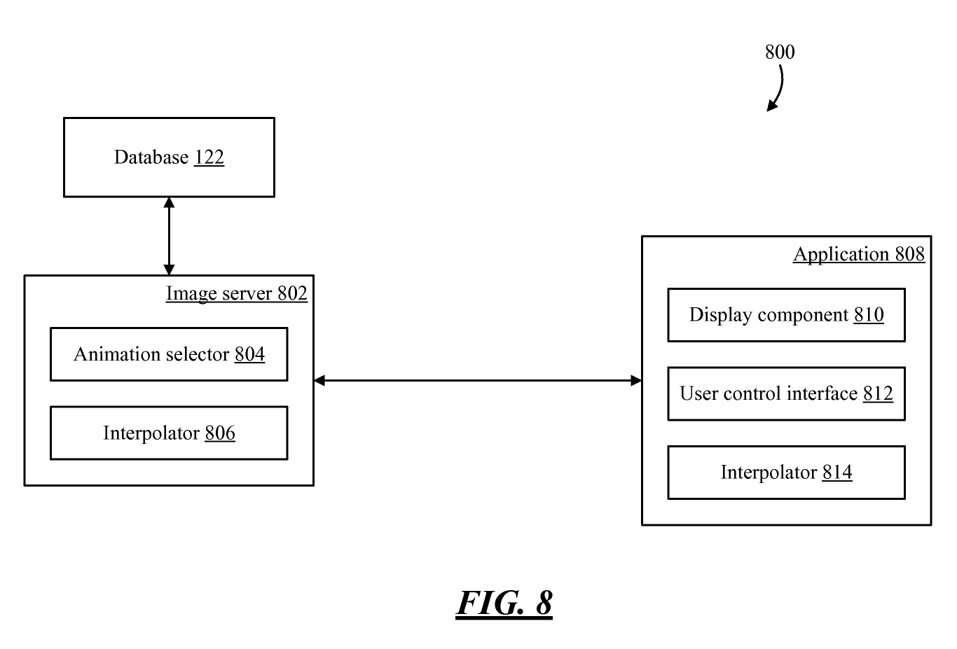

FIG. 8 shows an example system 800 in which images may be served, and in which those images may be used by an application, such as a map application or viewer application.

Image server 802 is a machine that provides images that may be used in navigation. For example, image server 802 may provide street-level images that an on-line map application may use to show a street-level view of a particular street on a map. Image server may retrieve images from database 122 (shown in FIG. 1), which may, for example store images in the form of multi-stream files. (Such multi-stream files are described above in connection with FIGS. 3 and 4.)

Image server 802 may comprise an animation selector 804. Animation selector may choose various aspects of how to deliver images to an application, such as the frame rate, the resolution of the images, what portion of a panoramic image to show, etc. Image server 802 may also include an interpolator 806. As noted above, there may be reason to increase the frame rate beyond the actual capture rate of bubbles, in which case intermediate frames are interpolated between the actual captured bubbles. Interpolator 806 may be used to perform the interpolation, using techniques such as those described above.

Application 808 is a program that consumes images provided by image server 802. For example, application 808 may be an on-line or desktop map application. If application 808 is an on-line application, then application 808 typically resides on its own server, which is accessible to clients (e.g., desktop computers, laptop computers, handheld computers, wireless telephones, etc.) through an internet browser. If application 808 is a desktop application, then application 808 typically resides on a personal computing device (e.g., desktop, laptop, handheld, etc.), and may communicate with image server 802 directly.

Application 808 may include a display component 810 with renders images provided by image server 802, and a user control interface 812 which allows users to control the images that they see (e.g., by moving forward or backward, turning at intersections or forks, panning, etc.). As noted above, frame interpolation may take place on either a client or a server, so application 808 may comprise an interpolator 814. Thus, image server 802 might cause intermediate frames to be rendered either by using its interpolator 806 to interpolate the frames and then serving the interpolated frames to application 808. Or image server 802 might cause intermediate frames to be rendered by serving, to application 808, the information from which the intermediate frames could be calculated, in which case application 808's interpolator 814 may perform the calculation.

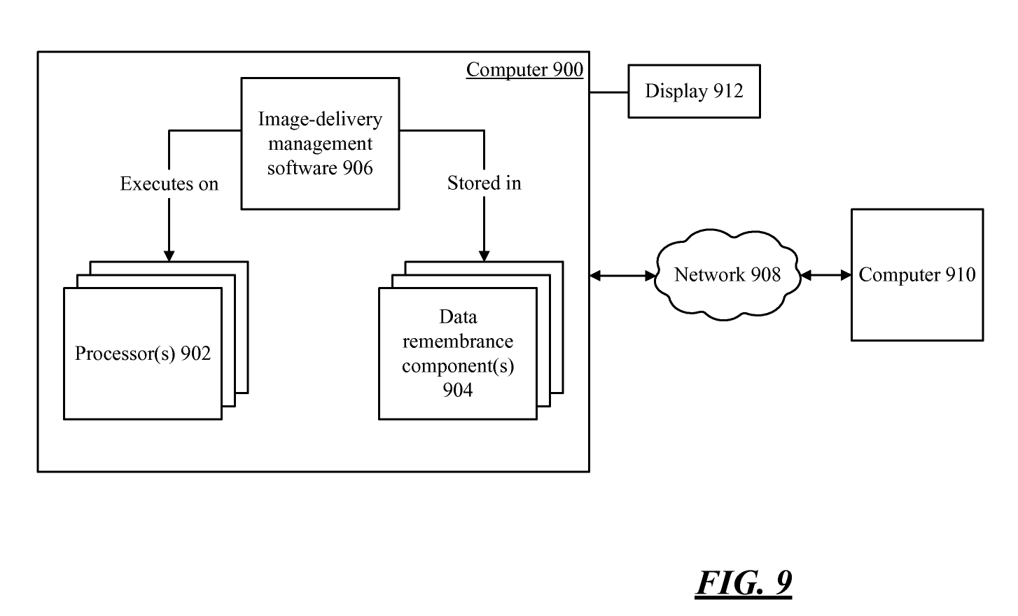

FIG. 9 shows an example environment in which aspects of the subject matter described herein may be deployed.

Computer 900 includes one or more processors 902 and one or more data remembrance components 904. Processor(s) 902 are typically microprocessors, such as those found in a personal desktop or laptop computer, a server, a handheld computer, or another kind of computing device. Data remembrance component(s) 904 are components that are capable of storing data for either the short or long term. Examples of data remembrance component(s) 904 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 900 may comprise, or be associated with, display 912, which may be a cathode ray tube (CRT) monitor, a liquid crystal display (LCD) monitor, or any other type of monitor.

Software may be stored in the data remembrance component(s) 904, and may execute on the one or more processor(s) 902. An example of such software is image-delivery management software 906, which may implement some or all of the functionality described above in connection with FIGS. 1-8, although any type of software could be used. Software 906 may be implemented, for example, through one or more components, which may be components in a distributed system, separate files, separate functions, separate objects, separate lines of code, etc. A computer (e.g., personal computer, server computer, handheld computer, etc.) personal computer in which a program is stored on hard disk, loaded into RAM, and executed on the computer's processor(s) typifies the scenario depicted in FIG. 9, although the subject matter described herein is not limited to this example. As yet another example, the subject matter herein could be deployed on a navigation device (e.g., an automobile navigation device, a cycling or walking navigation device, etc.).

The subject matter described herein can be implemented as software that is stored in one or more of the data remembrance component(s) 904 and that executes on one or more of the processor(s) 902. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 902) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 900 may be communicatively connected to one or more other devices through network 908. Computer 910, which may be similar in structure to computer 900, is an example of a device that can be connected to computer 900, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions that, when executed by a computer, cause the computer to perform acts comprising:
receiving a first indication of a geographic position;
receiving a second indication of a view direction;
receiving a third indication of a speed of motion;
based on criteria comprising: (a) said first indication, (b) said second indication, (c) said third indication, and (d) an amount of data transmission bandwidth that is available, choosing one or more aspects of image delivery, said aspects comprising:
a first resolution;
a field of view; and
a frame rate; and
providing a plurality of portions of panoramic images at said first resolution, wherein each portion of a panoramic image comprises said field of view, wherein said portions of said panoramic images are delivered in succession at said frame rate.

2. The one or more computer-readable storage media of claim 1, and wherein the portions of said panoramic images that are provided comprise said field of view but do not include the entire visual field through which said panoramic images are captured.

3. The one or more computer-readable storage media of claim 1, wherein said panoramic images are captured in a sequence at a capture rate, wherein said frame rate is lower than said capture rate, and wherein said providing comprises:
omitting, from the images that are provided, some of the panoramic images in said sequence, in order to prevent an amount of data used in transmitting said images from exceeding said bandwidth.

4. The one or more computer-readable storage media of claim 1, wherein said panoramic images are captured at a second resolution that is higher than said first resolution, and wherein said acts further comprise:
choosing said first resolution in order to prevent an amount of data used in transmitting said images from exceeding said bandwidth.

5. The one or more computer-readable storage media of claim 1, wherein said panoramic images are captured in a sequence at a capture rate, wherein said frame rate is higher than said capture rate, and wherein said acts further comprise:
interpolating intermediate images between panoramic images in said sequence.

6. The one or more computer-readable storage media of claim 1, wherein said panoramic images are stored in a file that has a plurality of streams, each of said streams corresponding to a tile of said panoramic images, and wherein said acts further comprise:
identifying one or more streams in said file that correspond to said field of view; and
providing images from the one or more streams that were identified by said identifying act.

7. The one or more computer-readable storage media of claim 1, wherein said panoramic images are capture from a first street that forks into a second street and a third street, wherein a file stores a first set of streams that store portions of panoramic images of said second street and a second set of streams that store portions of panoramic images of said third street, and wherein said acts further comprise:
receiving an fourth indication that a user has chosen to travel on said second street; and
based on said fourth indication, providing images from said first set of streams.

8. The one or more computer-readable storage media of claim 1, wherein said acts further comprise:
anticipating a change in said speed of motion, said geographic position, or said view direction; and
providing images to a viewer application based on the change that is anticipated.

9. A system for simulating navigation through an area, the system comprising:
a database that stores panoramic images;
an image server that receives a first indication of a geographic position, a second indication of a view direction, and a third indication of a speed of motion, said image server comprising:
an animation selector that determines one or more aspects of transmitting images based on factors comprising (a) said first indication, (b) said second indication, (c) said third indication, and (d) an amount of bandwidth available to transmit data, wherein said image server receives said panoramic images from said database and determines how to transmit said panoramic images, or portions of said panoramic images, so as not exceed said bandwidth.

10. The system of claim 9, wherein said one or more aspects comprise a first resolution at which to transmit said panoramic images or portions of said panoramic images, wherein said panoramic images are captured at a second resolution, and wherein said database stores said panoramic images at a plurality of resolutions, at least one of which is lower than said second resolution.

11. The system of claim 10, wherein said first resolution is lower than said second resolution, and wherein said image server retrieves a file from said database that comprises said panoramic images at said first resolution and transmits said panoramic images, or portions of said panoramic images, at said second first resolution.

12. The system of claim 9, wherein said one or more aspects comprise a field of view that will be shown to a user, said field of view comprising part of a visual field through which said panoramic images were captured, and wherein said image server chooses one or more portions of said panoramic images, said one or more portions being chosen to include said field of view, said one or more portions also being chosen to omit at least some of said visual field that will not be shown to said user.

13. The system of claim 9, wherein said one or more aspects comprise a field of view that will be shown to a user, wherein said panoramic images were captured through visual field, wherein said database stores a multi-stream file in which each stream represents a different portion of the visual field through which said panoramic image was captured, and wherein said image server chooses one or more of the streams from the file based on which of the streams comprise said field of view.

14. The system of claim 9, wherein said one or more aspects comprise a speed at which motion is to be simulated for a user, wherein said panoramic images were captured at a capture rate, said panoramic images being stored in said database in a sequence in which said panoramic images were captured, and wherein said image server provides said panoramic images or portions of said panoramic images by omitting some of said panoramic images in said sequence to accommodate said bandwidth.

15. The system of claim 9, wherein said one or more aspects comprise a speed at which motion is to be simulated for a user, wherein said panoramic images were captured at a capture rate, said panoramic images being stored in said database in a sequence in which said panoramic images were captured, and wherein the system further comprises:
an interpolator that interpolates intermediate images between said panoramic images in said sequence in order to increase smoothness of transitions between images.

16. The system of claim 9, wherein said one or more aspects comprise a speed at which motion is to be simulated for a user, wherein said panoramic images were captured at a capture rate, said panoramic images being stored in said database in a sequence in which said panoramic images were captured, and wherein said image server provides, to an application that receives said panoramic images or portions of said panoramic images, data that is usable by said application to interpolate intermediate images between said panoramic images in said sequence.

17. The system of claim 9, wherein said image server anticipates a change in said speed of motion, said geographic position, or said view direction, and provides images to a viewer application based on the change that is anticipated.

18. A method of providing a street-level view, the method comprising:
using a processor to perform acts comprising:
receiving a first indication of a geographic position along a street;
receiving a second indication of a direction;
receiving a third indication of a speed of travel;
determining an amount of bandwidth that is available to transmit data;
retrieving, from a database, a first file that contains panoramic images captured along said street, each of said panoramic images being captured through a first angle;
choosing an arc of said panoramic images to serve, said arc having an second angle that is less than said first angle;
choosing a first resolution and a frame rate such that transmission portions of said panoramic images at said first resolution and at said frame rate does not exceed said bandwidth;
serving, to an application, a plurality of images, at said first resolution, wherein said plurality of images constitute portions of said panoramic images that correspond to said arc, wherein said plurality of images are served at said frame rate.

19. The method of claim 18, wherein said first file comprises successive images that were captured along said street, said first file being a multi-stream file, each stream in said first file corresponding to a portion of said first angle through which said panoramic images were captured, and wherein said serving comprises:
serving one or more streams of said first file that encompass said arc.

20. The method of claim 18, wherein said panoramic images were captured at a second resolution that is higher than said first resolution, said first file storing said panoramic images at said first resolution, said database also storing a second file that stores said panoramic images at said second resolution, and wherein the method further comprises:
using a processor to perform acts comprising:
choosing said first file from said database based on a fact that said first file stores said panoramic images at said first resolution.
